(19) United States
(12) Patent Application Publication
(10) Pub. No.: US 2018/0134241 A1
(43) Pub. Date: May 17, 2018

(54) AUTOMOBILE

(71) Applicant: BOE TECHNOLOGY GROUP CO., LTD., Beijing (CN)

(72) Inventor: Um Yoon Sung, Beijing (CN)

(21) Appl. No.: 15/676,768

(22) Filed: Aug. 14, 2017

(30) Foreign Application Priority Data
Nov. 14, 2016 (CN) 201621223754.4

(51) Int. Cl. B60R 19/02; B60R 21/0136

(52) U.S. Cl. CPC B60R 19/023; B60R 2019/007; B60R 21/0136

(57) ABSTRACT

Embodiments of the present disclosure provide an automobile. The automobile includes a housing; and a protection device arranged between the housing and a cabin of the automobile; wherein a buffer cushion is formed by at least a part of the protection device, when a collision of the automobile occurs.

### CROSS-REFERENCE TO RELATED APPLICATION

This application claims the benefit of the Chinese Patent Application No. 201621223754.4 filed on Nov. 14, 2016 in the State Intellectual Property Office of China entitled “Automobile”, the whole disclosure of which is incorporated herein by reference.

### BACKGROUND

Technical Field

Embodiments of the present disclosure relate to a technical field of automobile techniques, and more particularly, to an automobile.

Description of the Related Art

With increasing improvement of people's lives, an amount of automobiles is also progressively increased. This results in occurrence of traffic accidents on the rise. Thus, human body and property safety of the people are threatened by the traffic accidents to large extent.

At current, when a traffic accident occurs, a vehicle will often be deformed due to collision with another vehicle. When the impact between the vehicles is very severe, a driver's cab in which a passenger rides will also be deformed, thus causing the damage to the passenger, and even the death of the passenger. When the driver's cab of the automobile does not have large deformation, the impacting force generated upon occurrence of the traffic accident can be alleviated due to the presence of safety bag in the driver's cab. In this way, the passenger can be protected. However, if the impacting force is too large or the automobile is bumped into a sharp object so as to make the automobile have the relatively large deformation, because the driver's cab also deforms, it is not sufficient to protect the passenger even if there is provided with the safety bag therein.

### SUMMARY

An embodiment of the present disclosure provides an automobile.

In accordance with one aspect of the present disclosure, it provides an automobile, comprising:

a housing; and

a protection device, arranged between the housing and a cabin of the automobile;

wherein a buffer cushion is formed by at least a part of the protection device, upon a collision of the automobile.

In one example, the protection device comprises a collision sensor, an electronic control unit, a gas generator and a gas inflatable cap;

wherein the collision sensor is configured to detect collision degree of the automobile, and send a detected signal to the electronic control unit;

the electronic control unit is connected with the collision sensor, and configured to determine whether to trigger the gas generator or not depending on the detected signal of the collision sensor; and

the gas generator is connected with the electronic control unit, and configured to generate gas under a control of the electronic control unit and fill the gas inflatable cap with the gas so that the gas inflatable cap forms the buffer cushion.

In one example, the protection device is arranged at at least one of a front side, a back side, a left side and a right side of the cabin of the automobile.

In one example, the protection device is provided at a position in front of a front wheel, and/or between the front wheel and the cabin of the automobile.

In one example, the protection device is provided at a position behind a back wheel, and/or between the back wheel and the cabin of the automobile.

In one example, two of the protection devices are provided between the front wheel and the cabin of the automobile, wherein one is arranged opposite to a driver's seat and the other one is arranged opposite to a co-driver's seat.

In one example, two of the protection devices are provided between the back wheel and the cabin of the automobile, wherein one is arranged opposite to a driver's seat and the other one is arranged opposite to a co-driver's seat.

In one example, the housing comprises a door shell, and the protection device is provided between the door shell and the cabin of the automobile.

In one example, the gas inflatable cap is arc-shaped, and bends away from the cabin of the automobile.

In one example, a material of the gas inflatable cap is rubber.

In one example, the gas inflatable cap has a single layer cap body.

In one example, the gas inflatable cap comprises an outer layer cap body and an inflatable bag within the outer layer cap body, and the outer layer cap body has a larger hardness than that of the inflatable bag.

In one example, the gas inflatable cap comprises a plurality of gas inflatable sub-caps which successively adjoin together in a direction from a position close to the cabin of the automobile to a position far away from the cabin.

In one example, the gas inflatable cap comprises at least one isolation membrane provided within the gas inflatable cap along a direction from a position close to the cabin of the automobile to a position far away from the cabin, and the gas inflatable cap is separated by the at least one isolation membrane into at least two gas inflatable sub-caps.

In one example, the gas inflatable cap comprises at least one isolation membrane provided within the gas inflatable cap along a direction from a position close to the cabin of the automobile to a position far away from the cabin, and the gas inflatable cap is separated by the at least one isolation membrane into at least two gas inflatable sub-caps.

### BRIEF DESCRIPTION OF THE DRAWINGS

In order to clearly describe technique schemes in embodiments of the present disclosure or in the prior art, accompanying drawings used for illustrating these embodiments will be simply described below. Obviously, the accompanying drawings described below merely refer to some of embodiments of the present disclosure, and those ordinary skilled in the art may arrive at other accompanying drawings based on these accompanying drawings without any inventive efforts.

FIG. 1 is a photograph showing a deformation presented after collision of two automobiles with each other;

FIG. 2a is a structural schematic diagram of a body shell of the automobile;

FIG. 2b is a structural schematic diagram of a housing of the automobile;

FIG. 3 is a structural schematic diagram of a protection device in accordance with an embodiment of the present disclosure;

FIG. 4 is a schematic diagram for showing a principle that an inflatable cap is used to reduce the deformation of the automobile in accordance with an embodiment of the present disclosure;

FIG. 5a is a first structural schematic diagram of a position where the protection device is arranged in the automobile in accordance with an embodiment of the present disclosure;

FIG. 5b is a second structural schematic diagram of a position where the protection device is arranged in the automobile in accordance with an embodiment of the present disclosure;

FIG. 5c is a third structural schematic diagram of a position where the protection device is arranged in the automobile in accordance with an embodiment of the present disclosure;

FIG. 6 is a fourth structural schematic diagram of a position where the protection device is arranged in the automobile in accordance with an embodiment of the present disclosure;

FIG. 7 is a fifth structural schematic diagram of a position where the protection device is arranged in the automobile in accordance with an embodiment of the present disclosure;

FIG. 8 is a sixth structural schematic diagram of a position where the protection device is arranged in the automobile in accordance with an embodiment of the present disclosure;

FIG. 9a is a first structural schematic diagram of the inflatable cap in accordance with an embodiment of the present disclosure; and

FIG. 9b is a second structural schematic diagram of the inflatable cap in accordance with an embodiment of the present disclosure.

### DETAILED DESCRIPTION OF PREFERRED EMBODIMENTS

Below, technical solutions of embodiments of the present disclosure will be described clearly and completely in conjunction with the accompanying drawings therein. Obviously, the described embodiments are only a part of the embodiments of the present disclosure, rather than all of the embodiments. Based on the embodiments in the present disclosure, an ordinary person skilled in the art will arrive at other embodiments without any creative efforts, which shall belong to the scope of the present disclosure.

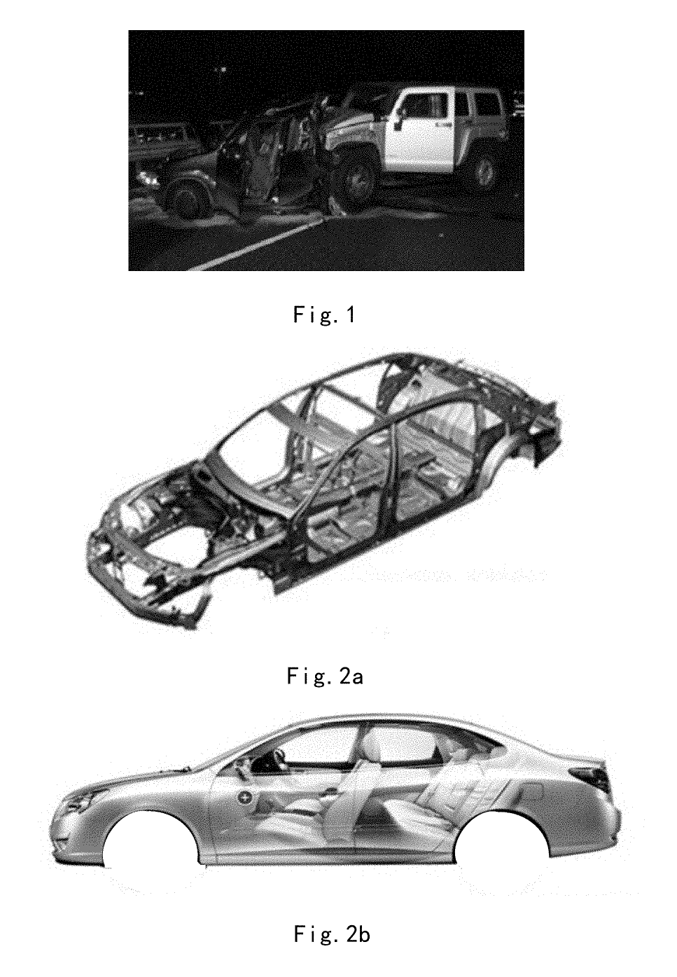

As shown in FIG. 1, it is an actual photograph of a traffic accident that occurred. An automobile on a right side collides with another automobile on a left side. During the collision, the automobile on the left side is severely deformed. At this time, the safety bag commonly used in the automobile on the left side does not have any substantial effect on protecting the passenger. Therefore, as for the traffic accident that the automobile is largely deformed, it is not sufficient to protect the passenger by the commonly used safety bag.

An embodiment of the present disclosure provides an automobile, including a housing and a protection device provided between the housing and a cabin of the automobile. When a collision of the automobile happens, at least one part of the protection device is used to form a buffer cushion.

Please note that firstly, a structure of the automobile includes a body shell as shown in FIG. 2a, and components such as an engine cover, a luggage cover, a car roof cover, car doors, car windows, cowl panels, fenders and wheels, installed on the body shell. The body shell is a basis for installing all the components onto the body, and normally meant to a rigid space arrangement consisting of main force bearing elements such as longitudinal beams, cross beams and pillars as well as plates connecting with them.

Concerning the above, the housing herein is referred to the parts of an outer surface of the automobile which may be seen by the human eyes from the outside. Specifically, for example, the housing can include the body shell on the outer surface of the automobile and the engine cover, the luggage cover or an outer shell of the car door installed on the body shell, which can be seen by the human eyes. The person skilled in the art should understand that the housing herein does not include the wheels of the automobile, the door glass of the automobile, and windshield glass of the automobile.

Secondly, it is not intended to make any limitation to the position where the protection device is arranged. In other words, the protection device can be located at any position between the housing of the automobile and the cabin of the automobile, for example, at a position between the engine cover and the cabin of the automobile; and/or between the luggage cover and the cabin of the automobile; and/or between the door shell of the automobile and the cabin of the automobile; and/or between the roof cover of the automobile and the cabin of the automobile, or the like. In one example of the disclosed embodiments, the protection device can be provided at a position between the housing of the automobile and the cabin of the automobile where the automobile tends to be collided with another automobile.

In addition, the present disclosure makes no limitation to the amount of the protection device to be provided, and the amount can be correspondingly set according to actual requirement, for example to be one, two or more.

Thirdly, the present disclosure does not make any limitation to the specific structure of the protection device, as long as the buffer cushion can be formed upon the automobile is impacted. On a basis of this, since at least one part of the protection device can form the buffer cushion upon the collision, and the volume is increased, a sufficient space shall be reserved in advance between the housing of the automobile and the cabin of the automobile, so as to ensure it can house the buffer cushion.

An embodiment of the present disclosure provides an automobile. A protection device is provided between the housing and the cabin of the automobile. When the automobile is collided, because the protection device can form the buffer cushion which can disperse the impact force acted on the automobile, it can prevent a relatively large deformation during the collision of the automobile, thereby protecting the safety of the passenger.

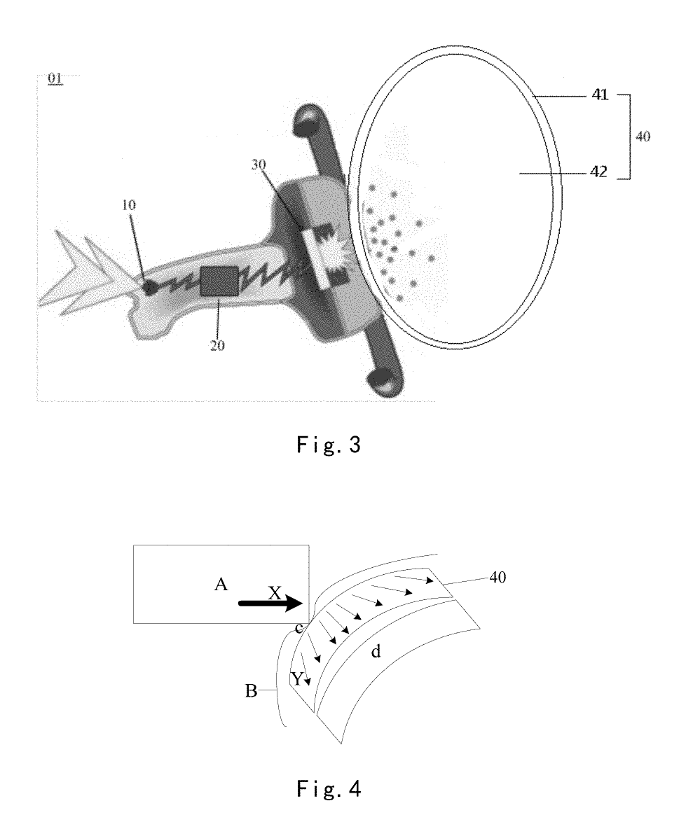

As shown in FIG. 3, the protection device 01 includes a collision sensor 10, an electronic control unit 20, a gas generator 30 and an inflatable cap 40. The collision sensor 10 is used to detect a collision degree of the automobile and send a detected signal to the electronic control unit 20. The electronic control unit 20 is connected with the collision sensor 10, and is used to determine whether the gas generator 30 is triggered or not depending on the detected signal of the collision sensor 10. The gas generator 30 is connected with the electronic control unit 20, used to generate the gas under the control of the electronic control unit 20 and to inflate the inflatable cap 40 so that the inflatable cap 40 forms the buffer cushion.

Specifically, the collision degree detected by the collision sensor 10 can include deceleration or inert force detected upon the collision.

The protection device 01 has the following working process: upon receiving the signal detected by the collision sensor 10, the electronic control unit 20 compares it with a preset value; when the detected signal (for example deceleration) exceeds the preset value (i.e., it is necessary to open the inflatable cap 40), it is determined that the electronic control unit 20 sets out a firing signal at once to trigger the gas generator 30. After receiving the firing signal, the gas generator 30 will ignite a gas-forming agent (for example sodium azide) within the gas generator 30. During the process of ignition, the gas-forming agent will release a large amount of gas immediately, and through filtration and cooling, the gas will be filled into the gas inflatable cap 40 so that volume of the gas inflatable cap 40 will rapidly expand within a very short time.

In addition, the present disclosure does not make any limitation to the gas generated by the gas generator 30, for example nitrogen, nitrogen dioxide or the like. On this basis, there is no limitation on the material of the gas inflatable cap 40. For example, the gas inflatable cap 40 can be formed from nylon, and an inner layer thereof is coated with polychloroprene, so that the gas inflatable cap 40 has a good airtightness.

It should be noted that a period that the gas generator 30 takes from a point when the ignition is performed upon receiving the ignition signal to a point when the gas inflation cap 40 is fully filled with gas, ranges from 0.02 second to 0.03 second. Therefore, when collision of the automobile occurs, the gas inflatable cap 40 can become a buffer cushion at very little time.

Herein, the principle that the gas inflatable cap 40 forms the buffer cushion to reduce the deformation of the automobile is: as shown in FIG. 4, when the automobile A collides with another automobile B with an impact force X, once there is no protection device provided between the housing of the automobile B and the cabin of the automobile B, the impact force acting at a position C of the automobile B is X. After being transferred to the body d of the automobile B, the impact force acting at the position d is still X (provided that it can neglect a loss during the transferring process of the impact force). In contrast, if a protection device 01 (the gas inflatable cap 40 is only schematically shown out in FIG. 4) is provided between the housing of the automobile B and the cabin of the automobile, when the automobile A collides with the automobile B at the position c, the gas inflatable cap 40 which is formed into the buffer cushion between the housing of the automobile B and the cabin of the automobile, can disperse and translate the impact force X into impact forces Y in a plurality of directions. The dispersed impact forces Y then are transferred to the body d of the automobile B. Because the impact force X is dispersed into the impact forces Y in different directions which then are transferred to the body d of the automobile B, the impact force does not concentrate at one point, but dispersing in directions. Therefore, it is possible to reduce the impact force acting on the body d of the automobile B, and the deformation of the automobile can be decreased.

Concerning the above, please be noted that even if the impact force X causes the gas inflatable cap 40 to explode or damage, during the explosion, due to loss of a part of energy, it can also reduce the impact force acting on the body d of the automobile.

In addition, when the gas inflatable cap 40 becomes rapidly expanded due to the filling of gas, because a large amount of gas flows into the gas inflatable cap 40 so that the pressure in the gas inflatable cap 40 rises which is harmful for absorbing the collision energy, it is possible to form ventilation holes on the gas inflatable cap 40 for discharging the gas in the gas inflatable cap 40 and releasing the collision energy. In this way, the impact force acting on the body d of the automobile can also be reduced.

In an embodiment of the present disclosure, since the protection device 01 includes the collision sensor 10, the electronic control unit 20, the gas generator 30 and the gas inflatable cap 40, upon the collision, they all function together so that the gas inflatable cap 40 forms the buffer cushion, thereby damping the impact force acting on the automobile and reducing the deformation of the automobile.

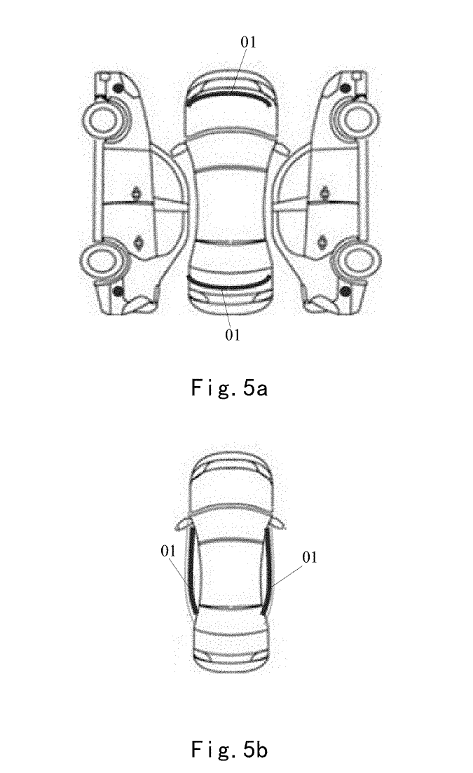

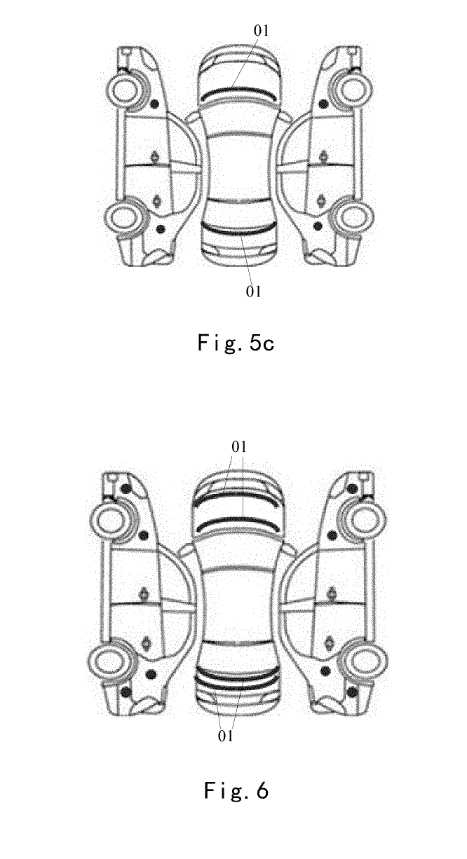

In one example, as shown in FIGS. 5a, 5b and 5c, the protection device 01 is at least arranged at one of a front, a back, a left side and a right side of the cabin in the automobile.

The protection devices 01 can be distributed at any one, two or three of the front, the back, the left side and the right side of the cabin of the automobile. Of course, the protection devices 01 can also be provided at all the four sides (i.e., the front, the back, the left side and the right side) at the same time. In addition, the protection device 01 can also be positioned as actually required.

On this basis, there is no limitation about the specific locations that the protection device 01 can be distributed at the front of the automobile cabin, for example at a position in front of the front wheel or the rear wheel of the automobile cabin as shown in FIG. 5a, between the front wheel and the automobile cabin, or between the rear wheel and the automobile cabin as shown in FIG. 5c. As such, there is also no limitation on the specific position at the back of the automobile cabin, the left side or the right side of the automobile cabin.

In addition, the number of the protection devices 01 which are provided in front of the automobile cabin is not limited herein. The number of the protection devices 01 can be reasonably set depending on the structure and its size at the front of the automobile cabin. As such, the number of the protection devices 01 provided behind the automobile cabin, at the left side or the right side thereof is also not limited herein.

In an embodiment of the present disclosure, there is less probability for the top of the automobile cabin to collide, and thus in order to save up the cost and reduce the volume of the automobile, there is no protection device 01 provided between the top of the housing and the automobile cabin. Instead, the protection device 01 is provided at at least one of the front, the back, the left side and the right side of the automobile cabin so as to reduce the impact force and the deformation of the automobile caused by the impact force.

In one example, as shown in FIG. 6, the protection devices 01 are provided at a position in front of the front wheel and/or between the front wheel and the automobile cabin; and/or the protection device 01 can be provided at a position behind the rear wheel and/or between the rear wheel and the automobile cabin.

Concerning the above, illustratively, one protection device 01 can be provided at a position between the front wheels or between the front wheel and the automobile cabin, at a position behind the rear wheel or between the rear wheel and the automobile cabin; or the protection devices 01 are provided both at a position between the front wheels and a position between the front wheel and the automobile cabin, and the protection device 01 is provided at a position behind the rear wheel; or the protection devices 01 are provided both at a position in front of the front wheel and a position between the front wheel and the automobile cabin, and the protection device 01 is provided at a position between the rear wheel and the automobile cabin; or the protection device 01 is provided at a position in front of the front wheel, the protection devices 01 are provided at a position behind the rear wheel and between the rear wheel and the automobile cabin; or the protection device 01 is provided between the front wheel and the automobile cabin, and the protection devices 01 are provided at a position behind the rear wheel and a position between the rear wheel and the automobile cabin; or the protection devices 01 are provided both at a position in front of the front wheel and between the front wheel and the automobile cabin, and the protection devices 01 are provided both at a position behind the rear wheel and between the rear wheel and the automobile cabin.

In an embodiment of the present disclosure, when the protection devices 01 are provided both at a position in front of the front wheel and between the front wheel and the automobile cabin, and/or the protection devices 01 are provided both at a position behind the rear wheel and between the rear wheel and the automobile cabin, this arrangement makes two protection devices 01 provided in the front of the automobile cabin and/or behind the automobile cabin. Because each protection device 01 can disperse the impact force acting on the automobile and reduce the deformation of the automobile, the two protection devices 01 can better disperse the impact force acting on the automobile and reduce the deformation of the automobile, thereby improving the safety of the passengers.

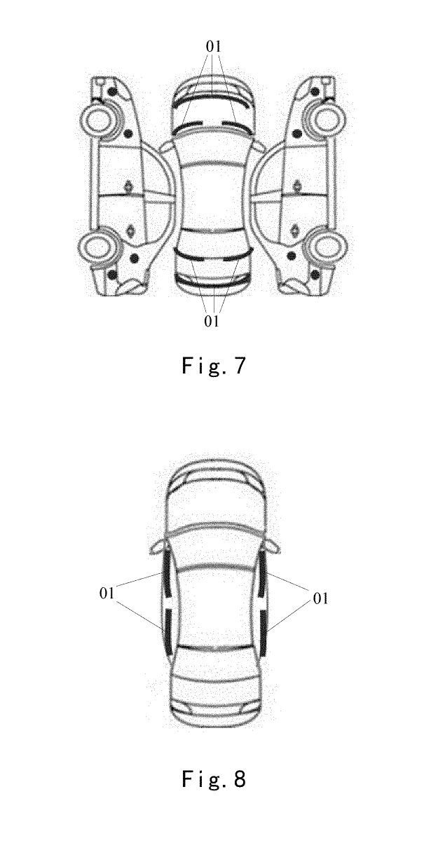

In one example, as shown in FIG. 7, two protection devices 01 are provided between the front wheel and the automobile cabin, in which one is arranged opposite to a driver's seat and the other one is arranged opposite to a co-driver's seat; and/or two protection devices 01 are provided between the rear wheel and the automobile cabin, in which one is arranged opposite to a driver's seat and the other one is arranged opposite to a co-driver's seat.

It should be noted that in a case that two protection devices 01 are provided between the front wheel and the automobile cabin, it is possible or not to provide a protection device 01 at a position in front of the front wheel. As such, under a circumstance that two protection devices 01 are provided between the rear wheel and the automobile cabin, it is possible or not to provide a protection device 01 at a position behind the rear wheel.

On this basis, it is feasible to only provide two protection devices 01 between the front wheel and the automobile cabin, or between the rear wheel and the automobile cabin. Of course, alternatively, the two protection devices 01 are provided not only between the front wheel and the automobile cabin, but also between the rear wheel and the automobile cabin.

Because it is typical that no passenger seats between the driver seat and the co-driver seat, in an embodiment of the present disclosure, when the protection devices 01 are provided between the front wheel and the automobile cabin, or between the rear wheel and the automobile cabin, the protection devices 01 are only needed to arrange at the positions opposite to the driver's seat and the co-driver's seat. As compared with the case that only one protection device 01 is provided, such protection devices 01 all are opposite to the driver's seat, the co-driver's seat and the position between the driver's seat and the co-driver's seat. In the embodiment of the present disclosure, one protection device 01 is arranged to correspond to the driver's seat and another protection device 01 is arranged to correspond to the co-driver's seat. Because each of the two protection devices 01 provided herein has less volume than that of one protection device which shall be provided, the two protection devices 01 provided in the present embodiment can be filled with gas rapidly to form the buffer cushion when the collision occurs.

In one example, as shown in FIGS. 5 and 8, the housing includes a door shell; and the protection device 01 is provided between the door shell and the automobile cabin.

The automobiles are classified into two kinds: those having one row of seats, and those having two rows of seats. When the automobile has one row of seats, as shown in FIG. 5b, the protection devices 01 can be respectively disposed between the door shell at the left side of the automobile and the automobile cabin, and between the door shell at the right side of the automobile and the automobile cabin. When the automobile has two rows of seats, as shown in FIG. 8, the protection devices 01 can be respectively disposed between a front door shell of the automobile and the automobile cabin, and between a back door shell thereof and the automobile cabin.

The present disclosure does not make any limitation on the number of the protection device 01 which can be provided between the door shell and the automobile cabin. Accordingly, the number of the protection device can be one or more.

In an embodiment of the present disclosure, because the protection devices 01 can be disposed between the door shell and the automobile cabin, when the door of the automobile is collided, it can reduce the deformation of the automobile door except the housing, thereby protecting the safety of the passenger.

In one example, as shown in FIGS. 5-8, the gas inflatable cap 40 is arc-shaped, and bends away from the automobile cabin.

Please be appreciated that during the manufacturing of the most automobiles, in order to make the appearance of the automobile more artistic, the housing of the automobile (for example the engine cover, the luggage cover of the automobile) essentially is curved.

On this basis, in order to adapt to the shape of the automobile, in one example, the gas inflatable cap 40 is arc-shaped. However, the curvature of the gas inflatable cap 40 is not limited herein, and can be correspondingly set depending on the curvature of the automobile housing, and the components provided between the automobile housing and the automobile cabin.

In an embodiment of the present disclosure, the gas inflatable cap 40 is made into the arc-shape, which bends away from the automobile cabin, so that the gas inflatable cap 40 can be better adapted to the shape of the automobile, and would do not expand due to the influence of the automobile structure design, when the gas inflatable cap 40 is expanding.

Because rubber has a good elasticity and does not tend to break down, in one example, the gas inflatable cap 40 is made of the rubber.

In one example, the gas inflatable cap 40 has a single layer cap body. Alternatively, the gas inflatable cap 40 includes an outer layer cap body and a gas inflatable bag within the outer layer cap body. In addition, the outer layer cap body has a larger hardness than that of the gas inflatable bag.

The gas inflatable cap 40 can be of a single layer or dual layers. When the gas inflatable cap 40 is of the dual layers, it can form the buffer cushion upon the collision while the outer layer cap body is used to protect the gas inflatable bag.

In an embodiment of the present disclosure, when the gas inflatable cap 40 is of a single layer, the gas inflatable cap 40 has a simple structure and the material thereof is saved up during the manufacturing. When the gas inflatable cap 40 includes an outer layer cap body 41 and a gas inflatable bag 42, because the outer layer cap body 41 has a larger hardness than that of the gas inflatable bag 42, the outer layer cap body 41 can serve to protect the gas inflatable bag 42 so as to prevent the breakage of the gas inflatable bag 42 during the collision and prolong the lifetime of the gas inflatable cap 40.

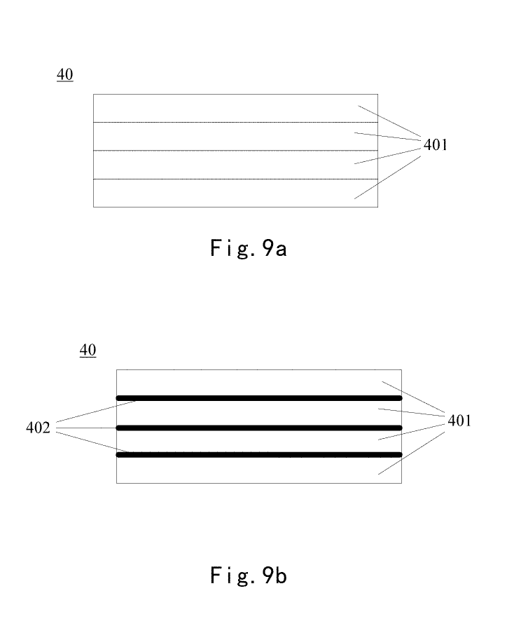

In one example, the gas inflatable cap 40 includes as shown in FIG. 9a, a plurality of gas inflatable sub-caps 401 adjoined in sequence along a direction from a position close to the automobile cabin to a position far away the automobile cabin; or as shown in FIG. 9b, at least one isolation membrane 402 located within the gas inflatable cap 40 and along a direction from a position close to the automobile cabin to a position far away the automobile cabin. The gas inflatable cap 40 is separated by the isolation membrane 402 into at least two inflatable sub-caps 401.

When the gas inflatable cap 40 includes a plurality of gas inflatable sub-caps 401 adjoined together in sequence, they can be adhered together by means of adhesives or other means. The present disclosure does not make any limitation on it. In addition, the volumes of the gas inflatable sub-caps 401 which adjoin together will be identical with each other or different from each other.

In a circumstance that the isolation membranes 402 are provided within the gas inflatable cap 40, the material of the isolation membranes 402 is not limited herein. The material of the isolation membranes 402 can be identical with that of the gas inflatable cap 40, or they are different from each other. On a basis of this, by using the isolation membranes 402, the gas inflatable cap 40 is separated into the gas inflatable sub-caps 401 having the same volume or different volumes. When one isolation membrane 402 is provided within the gas inflatable cap 40, the gas inflatable cap 40 may be separated into two gas inflatable sub-caps 401; and when two isolation membranes 402 are provided within the gas inflatable cap 40, the gas inflatable cap 40 may be separated into three gas inflatable sub-caps 401, and so on. The details will not be repeated herein.

In an embodiment of the present disclosure, because the gas inflatable cap 40 includes the plurality of gas inflatable sub-caps 401, once one of the gas inflatable sub-caps 401 is broken down during the collision, other gas inflatable sub-caps 401 can also disperse the impact force acting on the automobile, thereby reducing the deformation of the automobile.

Concerning the above, in order to better ensure the safety of the passenger, it is also possible to dispose a safety bag in the automobile cabin. Since the safety bag can have the same structure and working principle as those in the prior art, they are not repeatedly discussed herein.

The above description is merely exemplary embodiments of the present disclosure, and is not intended to limit the present disclosure. Changes, alternatives, or modifications made without departing from the spirit and principle of the present disclosure by those skilled in the art shall be included in the scopes of the present disclosure. Therefore, the scope of the present disclosure shall be defined by the appended claims.

What is claimed is:

1. An automobile, comprising:
a housing; and
a protection device, arranged between the housing and a cabin of the automobile;
wherein a buffer cushion is formed by at least a part of the protection device, upon a collision of the automobile.

2. The automobile according to claim 1, wherein the protection device comprises a collision sensor, an electronic control unit, a gas generator and a gas inflatable cap;
wherein the collision sensor is configured to detect collision degree of the automobile, and send a detected signal to the electronic control unit;
wherein the electronic control unit is connected with the collision sensor, and configured to determine whether to trigger the gas generator or not depending on the detected signal of the collision sensor; and
wherein the gas generator is connected with the electronic control unit, and configured to generate gas under a control of the electronic control unit and fill the gas inflatable cap with the gas so that the gas inflatable cap forms the buffer cushion.

3. The automobile according to claim 1, wherein the protection device is arranged at at least one of a front side, a back side, a left side and a right side of the cabin of the automobile.

4. The automobile according to claim 2, wherein the protection device is arranged at at least one of a front side, a back side, a left side and a right side of the cabin of the automobile.

5. The automobile according to claim 4, wherein the protection device is provided at a position in front of a front wheel, and/or between the front wheel and the cabin of the automobile.

6. The automobile according to claim 4, wherein the protection device is provided at a position behind a back wheel, and/or between the back wheel and the cabin of the automobile.

7. The automobile according to claim 5, wherein the protection device comprises first and second protection devices that are provided between the front wheel and the cabin of the automobile, wherein one is arranged opposite to a driver's seat and the other one is arranged opposite to a co-driver's seat.

8. The automobile according to claim 6, wherein the protection device comprises first and second protection devices that are provided between the back wheel and the cabin of the automobile, wherein one is arranged opposite to a driver's seat and the other one is arranged opposite to a co-driver's seat.

9. The automobile according to claim 1, wherein the housing comprises a door shell, and the protection device is provided between the door shell and the cabin of the automobile.

10. The automobile according to claim 2, wherein the housing comprises a door shell, and the protection device is provided between the door shell and the cabin of the automobile.

11. The automobile according to claim 2, wherein the gas inflatable cap is arc-shaped, and bends away from the cabin of the automobile.

12. The automobile according to claim 2, wherein a material of the gas inflatable cap is rubber.

13. The automobile according to claim 2, wherein the gas inflatable cap has a single layer cap body.

14. The automobile according to claim 2, wherein the gas inflatable cap comprises an outer layer cap body and an inflatable bag within the outer layer cap body, and the outer layer cap body has a larger hardness than that of the inflatable bag.

15. The automobile according to claim 11, wherein a material of the gas inflatable cap is rubber.

16. The automobile according to claim 11, wherein the gas inflatable cap has a single layer cap body.

17. The automobile according to claim 11, wherein the gas inflatable cap comprises an outer layer cap body and an inflatable bag within the outer layer cap body, and the outer layer cap body has a larger hardness than that of the inflatable bag.

18. The automobile according to claim 2, wherein the gas inflatable cap comprises a plurality of gas inflatable sub-caps which successively adjoin together in a direction from a position close to the cabin of the automobile to a position far away from the cabin.

19. The automobile according to claim 2, wherein the gas inflatable cap comprises at least one isolation membrane provided within the gas inflatable cap along a direction from a position close to the cabin of the automobile to a position far away from the cabin, and the gas inflatable cap is separated by the at least one isolation membrane into at least two gas inflatable sub-caps.

20. The automobile according to claim 17, wherein the gas inflatable cap comprises at least one isolation membrane provided within the gas inflatable cap along a direction from a position close to the cabin of the automobile to a position far away from the cabin, and the gas inflatable cap is separated by the at least one isolation membrane into at least two gas inflatable sub-caps.
